(19) United States
(12) Patent Application Publication
(10) Pub. No.: US 2018/0162218 A1
(43) Pub. Date: Jun. 14, 2018

(54) APPARATUS AND METHOD FOR COOLING MHSG OF MILD HYBRID ELECTRIC VEHICLE

(71) Applicants: Hyundai Motors Company, Seoul (KR); Kia Motors Corporation, Seoul (KR)

(72) Inventor: YoungMin KIM, Yongin-si (KR)

(73) Assignees: Hyundai Motor Company, Seoul (KR); Kia Motors Corporation, Seoul (KR)

(21) Appl. No.: 15/828,854

(22) Filed: Dec. 1, 2017

(30) Foreign Application Priority Data
Dec. 13, 2016 (KR) 10-2016-0169854

(51) Int. Cl. B60K 11/08; B60K 11/06; B60W 20/00

(52) U.S. Cl. CPC B60K 11/085; Y10S 903/904; B60W 20/00; B60K 11/06

(57) ABSTRACT

An apparatus and a method for cooling an MHSG of a mild hybrid electric vehicle may include: a current detector detecting a current applied to the MHSG; a timer detecting an elapsed time after a determined time; and a controller configured to determine whether a high temperature condition is satisfied according to signals of the current detector and the timer, and controlling an operation of an active air flap.

### CROSS-REFERENCE(S) TO RELATED APPLICATIONS

The present application claims priority to Korean Patent Application No. 10-2016-0169854, filed on Dec. 13, 2016, the entire contents of which is incorporated herein for all purposes by this reference.

### BACKGROUND OF THE INVENTION

### Field of the Invention

The present invention relates to an apparatus and a method for cooling a mild hybrid starter & generator (MHSG) of a mild hybrid electric vehicle, and, more particularly, to an apparatus and a method for cooling a MHSG of a mild hybrid electric vehicle according to a current applied to the MHSG.

### Description of Related Art

A hybrid electric vehicle utilizes an internal combustion engine and a battery power source in combination. The hybrid electric vehicle efficiently combines a torque of the internal combustion engine and a torque of a motor.

Hybrid electric vehicles may be divided into a hard type and a mild type according to a power sharing ratio between the engine and the motor. In the case of the mild type of hybrid electric vehicle (hereinafter referred to as a mild hybrid electric vehicle), a mild hybrid starter & generator (MHSG), configured to start the engine or generate electricity according to an output of the engine, is employed instead of an alternator. In the case of the hard type of hybrid electric vehicle, a driving motor configured for generating a driving torque is used in addition to an integrated starter & generator (ISG) configured to start the engine or generate electricity.

The MHSG may assist the torque of the engine according to a plurality of running states of the vehicle and may charge a battery (e.g., a 48 V battery) through regenerative braking device. Accordingly, a fuel efficiency of the mild hybrid electric vehicle may be improved.

Performance of the MHSG changes according to a temperature of the MHSG. When the MHSG is operated in a high temperature state (e.g., 150° C. or higher), the MHSG may burn out and/or overheat. Accordingly, there exists a demand for a method for cooling the MHSG.

The information disclosed in this Background of the Invention section is only for enhancement of understanding of the general background of the invention and should not be taken as an acknowledgment or any form of suggestion that this information forms the prior art already known to a person skilled in the art.

### BRIEF SUMMARY

Various aspects of the present invention are directed to providing an apparatus and a method for cooling an MHSG of a mild hybrid electric vehicle having advantages of determining whether cooling of the MHSG is required according to a current applied to the MHSG, and accordingly cooling the MHSG.

An apparatus for cooling a mild hybrid starter & generator (MHSG) of a mild hybrid electric vehicle according to an exemplary embodiment of the present invention includes a current detector configured to detect a current applied to the MHSG; a timer configured to detect an elapsed time after a determined time; and a controller configured to determine whether a high temperature condition is satisfied according to signals of the current detector and the timer, and the controller is configured to control an operation of an active air flap, wherein the controller opens the active air flap when the high temperature condition is satisfied.

The high temperature condition may be satisfied when a current greater than a predetermined value is applied to the MHSG for a predetermined time period.

The controller may be configured to determine and adjust a rotation speed of a cooling fan according to the current applied to the MHSG.

A method for cooling a mild hybrid starter & generator (MHSG) of a mild hybrid electric vehicle according to an exemplary embodiment of the present invention includes detecting a current applied to the MHSG using a current detector; determining whether a high temperature condition is satisfied according to the current applied to the MHSG; and opening an active air flap when the high temperature condition is satisfied.

The high temperature condition may be satisfied when a current greater than a predetermined value is applied to the MHSG for a predetermined time period.

The method may further include determining and adjusting a rotation speed of a cooling fan according to the current applied to the MHSG when the high temperature condition is satisfied.

According to an exemplary embodiment of the present invention, it is possible to determine whether the cooling of the MHSG is required according to the current applied to the MHSG. In addition, when the high temperature condition is satisfied, the active air flap is opened, cooling the MHSG.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a mild hybrid electric vehicle according to an exemplary embodiment of the present invention;

FIG. 2 is a block diagram illustrating an apparatus for cooling an MHSG of a mild hybrid electric vehicle according to an exemplary embodiment of the present invention; and

FIG. 3 is a flowchart illustrating a method for cooling an MHSG of a mild hybrid electric vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction exemplary embodiments, it will be understood that the present description is note intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Elements which are not related with the description are omitted for clearly describing the exemplary embodiments of the present invention.

Since each component in the drawings is arbitrarily illustrated for ease of description, the present invention is not particularly limited to the components illustrated in the drawings.

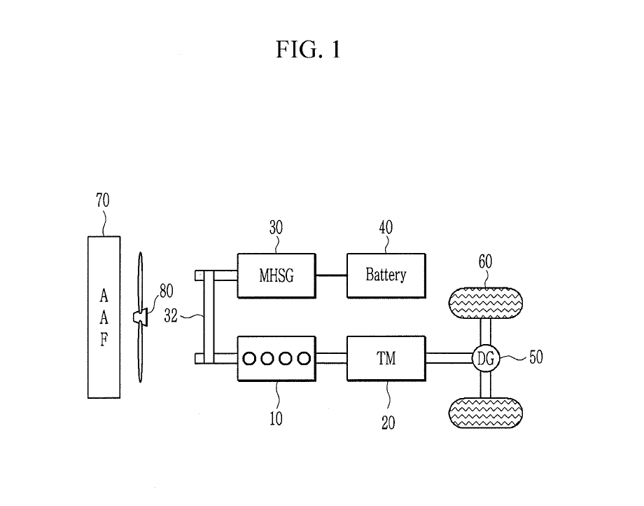

FIG. 1 is a block diagram of a mild hybrid electric vehicle according to an exemplary embodiment of the present invention.

As shown in FIG. 1, a mild hybrid electric vehicle according to exemplary embodiment of the present invention includes an engine 10, a transmission 20, a mild hybrid starter & generator (MHSG) 30, a battery 40, a differential gear apparatus 50, wheels 60, an active air flap 70, and a cooling fan 80.

The engine 10 combusts fuel and air to generate a torque, and various engines including a gasoline engine, a diesel engine, and a liquefied petroleum injection (LPI) engine may be used as the engine 10.

With reference to a torque transmission of the mild hybrid electric vehicle, the torque generated from the engine 10 is transmitted to an input shaft of the transmission 20, and a torque output from an output shaft of the transmission 20 is transmitted to an axle via the differential gear apparatus 50. The axle rotates the wheels 60 wherein the mild hybrid electric vehicle drives by the torque generated from the engine 10.

The MHSG 30 starts the engine 10 or generates electricity according to an output of the engine 10. In addition, the MHSG 30 may assist the torque of the engine 10. The torque of the engine 10 may be used as a main torque, and the torque of the MHSG 30 may be used as an auxiliary torque. The engine 10 and the MHSG 30 may be connected to each other by a belt 32.

The battery 40 may supply electricity to the MHSG 30, and may be charged through electricity recovered by the MHSG 30. The battery 40 may be a high voltage battery (e.g., a 48 V battery). The mild hybrid electric vehicle may further include a low voltage battery DC-DC converter (LDC) configured to convert a voltage supplied form the battery 40 into a low voltage, and a low voltage battery (e.g., a 12 V battery) supplying a low voltage to a plurality of electrical loads (e.g., a headlamp and an air conditioner).

The active air flap 70 is configured to control an air flow being introduced to an engine compartment of the vehicle. When the active air flap 70 is opened, external air is introduced to the engine compartment and the engine compartment is cooled. When the active air flap 70 is opened, the MHSG 30 may be cooled. When the active air flap 70 is closed, an engine warm-up is rapidly performed and an air resistance is reduced, improving a driving safety and fuel efficiency of the vehicle.

A controller 100 is configured to determine whether to operate the cooling fan 80, and adjusts a rotation speed of the cooling fan 80 accordingly. For example, the rotation speed of the cooling fan 80 may be increased in a plurality of incremental steps, or may be increased in four steps. As the rotation speed of the cooling fan 80 increase, the engine 10 and the MHSG 30 are rapidly cooled.

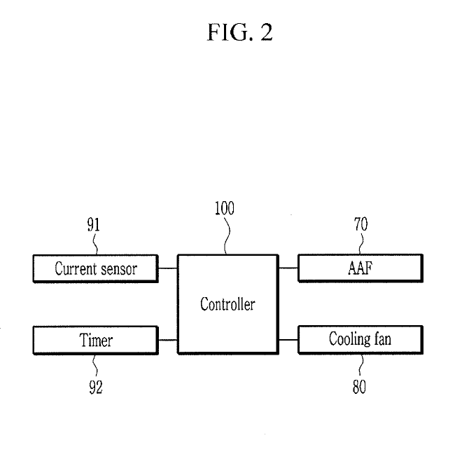

FIG. 2 is a block diagram illustrating an apparatus for cooling an MHSG of a mild hybrid electric vehicle according to an exemplary embodiment of the present invention.

As shown in FIG. 2, an apparatus for cooling an MHSG of a mild hybrid electric vehicle according to an exemplary embodiment of the present invention includes a current detector 91, a timer 92, the controller 100, the active air flap 70, and the cooling fan 80.

The current detector 91 is configured to detect a current applied to the MHSG 30, and transmits a signal corresponding thereto to the controller 100.

The timer 92 is configured to detect an elapsed time after a determined time.

The controller 100 is configured to determine whether a high temperature condition is satisfied according to the signals of the current detector 91 and the timer 92, and is configured to control an operation of the active air flap 70 and the cooling fan 80. The controller 100 may be configured to determine whether the MHSG 30 is in a high temperature state according to the current applied to the MHSG 30.

The controller 100 may be implemented with one or more processors executed by a predetermined program, and the predetermined program may include a series of commands for performing each step included in a method for cooling an MHSG of a mild hybrid electric vehicle according to an exemplary embodiment of the present invention to be described below.

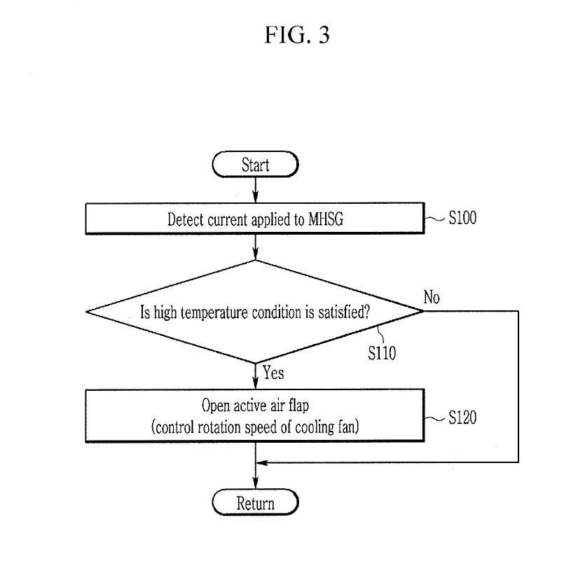

FIG. 3 is a flowchart illustrating a method for cooling an MHSG of a mild hybrid electric vehicle according to an exemplary embodiment of the present invention.

As shown in FIG. 3, the controller 100 is configured to detect the current applied to the MHSG 30 using the current detector 91 (S100).

The controller 100 is configured to determine whether the high temperature condition is satisfied using the timer 92 according to the current applied to the MHSG 30 (S110). The high temperature condition may be satisfied when a current greater than a predetermined value is applied to the MHSG 30 for a predetermined time period. For example, the high temperature condition may be satisfied when a current greater than 5 A is applied to the MHSG 30 for 120 seconds, a current greater than 10 A is applied to the MHSG 30 for 90 seconds, or a current greater than 15 A is applied to the MHSG 30 for 60 seconds. When the high temperature condition is satisfied, the controller 100 may determine that the MHSG 30 is in the high temperature state and cooling is required. When the high temperature state is continued, the MHSG 30 may not operate normally.

When the high temperature condition is not satisfied (S110), the controller 100 is configured to complete the method for cooling the MHSG according to an exemplary embodiment of the present invention.

When the high temperature condition is satisfied (S110), the controller 100 is configured to open the active air flap 70 (S120). As the active air flap 70 is opened, the MHSG 30 is cooled. In the present case, the controller 100 may be configured to control the rotation speed of the cooling fan 80 to assist the cooling of the MHSG 30. In detail, the controller 100 may be configured to determine and adjust the rotation speed of the cooling fan 80 according to the current applied to the MHSG 30. As the current applied to the MHSG 30 increases, the controller 100 may be configured to increase the rotation speed of the cooling fan 80.

As described above, according to an exemplary embodiment of the present invention, it is possible to determine whether cooling of the MHSG 30 is required according to the current applied to the MHSG 30. In addition, when the high temperature condition is satisfied, the active air flap 70 is opened to cool the MHSG 30.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the present invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for cooling a mild hybrid starter & generator (MHSG) of a mild hybrid electric vehicle, the apparatus comprising:
a current detector configured to detect a current applied to the MHSG;
a timer configured to detect an elapsed time after a determined time; and
a controller configured to determine whether a high temperature condition is satisfied according to signals of the current detector and the timer, and controlling an operation of an air flap,
wherein the controller is configured to open the air flap when the high temperature condition is satisfied.

2. The apparatus of claim 1, wherein the high temperature condition is satisfied when a current greater than a predetermined value is applied to the MHSG for a predetermined time period.

3. The apparatus of claim 1, wherein the controller is configured to determine a rotation speed of a cooling fan according to the current applied to the MHSG.

4. The apparatus of claim 1, wherein the controller is configured to adjust a rotation speed of a cooling fan in incremental steps according to the current applied to the MHSG.

5. A method for cooling a mild hybrid starter & generator (MHSG) of a mild hybrid electric vehicle, the method comprising:
detecting a current applied to the MHSG using a current detector;
determining whether a high temperature condition is satisfied according to the current applied to the MHSG; and
opening an air flap when the high temperature condition is satisfied.

6. The method of claim 5, wherein the high temperature condition is satisfied when a current greater than a predetermined value is applied to the MHSG for a predetermined time period.

7. The method of claim 5, further including determining a rotation speed of a cooling fan according to the current applied to the MHSG when the high temperature condition is satisfied.

8. The method of claim 5, further including adjusting a rotation speed of a cooling fan in incremental steps according to the current applied to the MHSG when the high temperature condition is satisfied.
